(19) United States
(12) Patent Application Publication
(10) Pub. No.: US 2017/0085508 A1
(43) Pub. Date: Mar. 23, 2017

(54) PHYSICAL ACTIVITY DATA MANAGEMENT

(71) Applicant: On-Site Solutions Physical Therapy, LLC, Maple Grove, MN (US)

(72) Inventor: Melissa GILL, Maple Grove, MN (US)

(21) Appl. No.: 15/269,783

(22) Filed: Sep. 19, 2016

Related U.S. Application Data
(60) Provisional application No. 62/220,474, filed on Sep. 18, 2015.

(51) Int. Cl. H04L 12/58; H04L 29/08; H04L 29/06; G06F 17/30

(52) U.S. Cl. CPC H04L 51/10; G06F 17/30702; H04L 67/306; H04L 67/42; H04L 67/10

(57) ABSTRACT

A system, method, and computer program product for managing physical activity data. In certain embodiments, managing physical activity data includes accessing, from a database communicatively connected with a server device, a set of stored user data indicating physical activity characteristics of a user. Managing physical activity data may include generating, using the server device and the set of stored user data, a physical activity profile that indicates a predicted physical activity deficiency for the user based on the set of stored user data, and determining a physical activity program from a database of a plurality of physical activity programs, the physical activity program including a digital image that depicts an exercise and instructional information for the exercise. Managing physical activity data may also include transmitting, via a network, a multimedia message service message including a portion of the physical activity program to a client device associated with the user.

### CROSS-REFERENCE TO RELATED APPLICATION

This application claims the benefit of U.S. Provisional Application No. 62/220,474, filed on Sep. 18, 2015.

### FIELD OF THE INVENTION

Aspects of the present disclosure are directed towards management of physical activity data.

### BACKGROUND

Physical activity programs, including instructions to an individual to perform an exercise, stretch, or other physical activity, may be used to improve health outcomes in various environments. For example, in a workplace environment, physical activity programs can be used to improve employee health and, as a result, may reduce of work-related injuries.

### SUMMARY

Physical activity programs may be generated for various users and customized at least partially based on a physical activity profile based on the various user's lifestyle, job, or based on other data that indicates some type of physical activity characteristic for a user. A particular physical activity program could be customized based on users who are in the labor industry, who are office workers, or in some other field of work, to tailor the program to counter issues particular to those users. For example, an electrician may perform work above head frequently through the day. Accordingly, a physical activity program for an electrician may include specific stretches that address those particular physical demands.

A physical activity program may also be based partially, or wholly, on recommendations by a health professional, such as a physician, physical therapist, and so on, to address a specific injury.

However, the users may need instructions to remember when to perform the physical activity, what to perform, how to perform it, or other details. This may lead to reduced compliance with various physical activity programs.

Accordingly, one or more embodiments are directed to a system for managing physical activity data. In some embodiments, the system includes a server device and a client device, the client device associated with a user and communicatively connected with the server device via a network, the server device and the client device each including a processor and a computer readable storage medium. In one or more embodiments, the computer readable storage medium of the server device includes instructions executable by the processor of the server device to cause the server device to access, from a database communicatively connected with the server device, a set of stored user data indicating physical activity characteristics of the user. In some embodiments, the instructions are executable by the processor of the server device to cause the server device to generate, based on the set of stored user data, a physical activity profile that indicates a predicted physical activity deficiency for the user based on the set of stored user data.

In some embodiments, the instructions are executable by the processor of the server device to cause the server device to determine a physical activity program from a database of a plurality of physical activity programs, the physical activity program including a digital image that depicts an exercise and instructional information for the exercise. In some embodiments, the instructions are executable by the processor of the server device to cause the server device to transmit, via a network, a portion of the physical activity program to the client device.

One or more embodiments are directed to a method for managing physical activity data. In some embodiments, the method includes generating, using the server device and the set of stored user data, a physical activity profile that indicates a predicted physical activity deficiency for the user based on the set of stored user data. In one or more embodiments, the method includes determining a physical activity program from a database of a plurality of physical activity programs, the physical activity program including a digital image that depicts an exercise and instructional information for the exercise. In some embodiments, the method includes transmitting, via a network, a multimedia message service message including a portion of the physical activity program to a client device associated with the user.

Some embodiments are directed to a computer program product for managing physical activity data. In certain embodiments the computer program product includes a computer readable storage medium having program instructions embodied therewith, wherein the computer readable storage medium is not a transitory signal per se. In one or more embodiments the program instructions are executable by a computer to cause the computer to perform a method including accessing, from a database communicatively connected with a server device, a set of stored user data indicating physical activity characteristics of a user. In one or more embodiments, the method includes generating, using the server device and the set of stored user data, a physical activity profile that indicates a predicted physical activity deficiency for the user based on the set of stored user data. In one or more embodiments, the method includes determining a physical activity program from a database of a plurality of physical activity programs, the physical activity program including a digital image that depicts an exercise and instructional information for the exercise. In some embodiments, the method includes transmitting, via a network, a multimedia message service message including a portion of the physical activity program to a client device associated with the user.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system for physical activity data management, according to one or more embodiments of the present disclosure.

FIG. 2 depicts a computing node, according to one or more embodiments of the present disclosure.

FIG. 3 depicts a flowchart diagram of a method of managing physical activity data, according to one or more embodiments of the present disclosure.

FIG. 4 depicts a flowchart diagram of a method of managing physical activity data, according to one or more embodiments of the present disclosure.

While embodiments are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the present disclosure.

### DETAILED DESCRIPTION

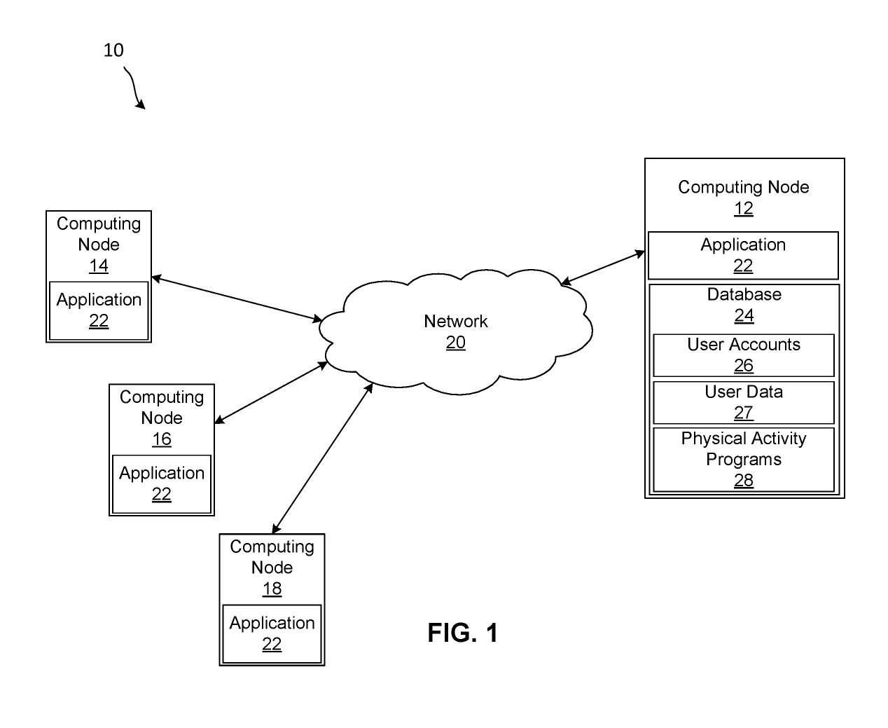

Referring to FIG. 1, a system 10 for physical activity data management is depicted, according to one or more embodiments of the present disclosure.

In one or more embodiments, the system 10 includes one or more computing nodes 12, 14, 16, 18. Computing nodes 12, 14, 16, 18, may be physical devices, usable by a consumer or other user, including processing elements and memory. In some embodiments, the computing nodes 12, 14, 16, 18, include, for example, a desktop computer, laptop computer, tablet device, smart phones, wearable computing device, or other suitable device. Seen in FIG. 1, computing nodes 12, 14, 16, 18, are interconnected via network 20, for communication. In one or more embodiments, the network 20 may be, for example, a local area network, a wide area network, a cloud computing environment, a public network (e.g. the internet), or other suitable network for communication between the computing nodes 12, 14, 16, 18.

In one or more embodiments, the system 10 outputs data and receives inputs to/from users via the computing nodes 12, 14, 16, 18. For example, the computing nodes 12, 14, 16, 18 may each include input/output devices, for example a display and/or touchscreen, for interfacing with a user via a graphical user interface (GUI) or other user interface.

In one or more embodiments, each of the computing nodes 12, 14, 16, 18 includes application 22 (“App”). In some embodiments, the App 22 is a program or “software” that is stored in memory accessible by computing nodes 12, 14, 16, 18 for execution on the computing nodes 12, 14, 16, 18. In one or more embodiments App 22 includes a set of instructions for execution by processing elements on one or more of the computing nodes 12, 14, 16, 18, for management of physical activity instructions. In certain embodiments, App 22 is stored locally on some or all of the computing nodes 12-18. In some embodiments, App 22 is stored remotely, accessible to some or all of the computing nodes 12-18 via network.

In some embodiments, when executing App 22, computing nodes 12, 14, 16, 18, are arranged in a client server architecture. For example, computing node 12 may be configured as a server with computing nodes 14, 16, and 18 arranged as clients. For example, depicted in FIG. 1, computing node 12 is a server including database 24, and computing nodes 14, 16, 18 are clients that use App 22 to communicate with the server to establish user accounts 26, input user data 27, and access one or more physical activity programs 28. In some embodiments, App 22 is an application dedicated to physical activity data management, configured to collect user data and/or display physical activity programs, including text, video, images, animated images, and the like, for depicting various exercises and stretches. In some embodiments, App 22 is a more generalized application, for example a text messaging application. In certain embodiments, the text messaging application can receive portions of the physical activity program, including text, video, images, animated images, and the like, for depicting various exercises and stretches, to display for the user.

In some embodiments, when executing App the computing nodes 12, 14, 16, 18 are arranged in a peer-to-peer architecture, with computing nodes 12, 14, 16, 18 acting as both client and server.

In one or more embodiments, each of the computing nodes 14, 16, 18 may be used with App 22 to access server (e.g. computing node 12) for access to one or more physical activity programs 28. In embodiments, the physical activity programs 28 are a set of instructions for performing one or more physical activities, for example, exercises, stretches, or other physical activity. In some embodiments, each physical activity program 28 includes 6-10 stretching/exercise activities. In certain embodiments each physical activity program may include additional or fewer activities.

In some embodiments, the set of instructions includes a visual indication, depicting portions of various physical activities in the program 28. For example, the visual indication may depict the position of the body for each exercise/stretch. In some embodiments, the set of instructions includes an audio component. In some embodiments, steps in set of instructions, include visual and/or audio indications. In some embodiments, visual and/or audio indicators are timed such that each step is displayed for a specific duration. In some embodiments, each activity will run for a specified amount of time. In some embodiments, each module activity will run for a specified number of cycles.

For example, in some embodiments, computing nodes 14, 16, 18 could access a physical activity program including a text message with a portion of a physical activity program. For example, in some embodiments, the text message could include informational instructions and a digital image depicting the stretch. In some embodiments, the digital image is a portion of a Graphics Interchange Format (GIF) image configured to animate the depicted exercise. For example, in some embodiments, the digital image includes an animated image of a stretch along with wording of “right” then “left” for each stretch as appropriate. After the “right” side is stretched, then the instructions and picture are shown for the “left” side. There is a brief pause to switch to exercise #2, then the process is repeated until all the stretches have been completed. In some embodiments, the digital image is included in a video that depicts the exercise and the instructional information.

In some embodiments, the physical activity program includes a timer. For example, in some embodiments, the physical activity program includes a 20 seconds timer countdown that is animated as a part of a GIF image that depicts an exercise. In some embodiments, the physical activity program includes a link or a Uniform Resource Locator (URL) that links to a portion of the physical activity program. For example, in some embodiments, a user could receive a text message including the URL. The user could select the URL to be brought to a portion of the physical activity program, including video, digital image, animated image, or the like, depicting an exercise.

In various embodiments, a portion of the physical activity program is transmitted to the client device as a Multimedia Messaging Service (MMS) message. In certain embodiments, the portion of the physical activity program transmitted to the client device is less than 600 kilobytes (KB) large. In certain embodiments, the portion of the physical activity program transmitted to the client device is less than 300 kilobytes (KB) large.

In some embodiments, the database 24 includes a library of physical activity programs. For example, in some embodiments, the database 24 includes 10-15 physical activity programs (Electrician program, Manufacturing program, etc.).

In some embodiments, the each physical activity program includes various physical activity data, for example, a program name and description, benefits of performing the exercises, guidelines for proper form, or other suitable information. In some embodiments, each of the physical activity programs 28 may have a program name and description based on the type of exercises included in the program. For example, physical activity programs 28 may include a “stretching” program that includes activities designed for stretching. Similarly, physical activity programs 28 may include an “Office Worker Program” that includes activities designed for users who are electricians.

When executing App 22, one or more of the computing nodes 12, 14, 16, 18 may be configured to communicate with a server to create one or more user accounts. For example, depicted in FIG. 1, computing node 12 is a server including database 24, and computing nodes 14, 16, 18 communicate via network 20 to establish user accounts 26. Computing nodes 14, 16, 18 may use App 22 by logging into user accounts 26 and communicating with the server.

The user accounts 26 may include an administrative account and one or more client accounts. In some embodiments, the administrative account may be a user account including privileges for configuring the system 10. For example, in some embodiments the administrative account may create or modify user accounts 26. In certain embodiments the administrative account may select one or more physical activity programs 28 for access to user accounts 26. In some embodiments, the administrative account may specify a term or expiration date for access to the physical activity programs 28. In one or more embodiments, the duration of each module activity is set by the server.

In some embodiments, the administrative account may assign which physical activity programs 28 are available to specific user accounts 26. In some embodiments, this decision may be based on user data 27. For example, in some embodiments, the administrative account selectively assigns modules based on employee need, job requirements, etc.

In some embodiments, the system 10 is configured to select physical activity modules for user accounts 26 based on user data 27.

In one or more embodiments, the user data 27 includes user information including, the user's name, date of birth, email address, phone number, and notification preferences. In some embodiments, the user data 27 includes job information, such as, for example, the user's job, department and position. In some embodiments, the user data 27 includes information on physical activity characteristics or habits of the user. Physical activity characteristics can include information on the activity level of the user, for example whether the user has a more sedentary or more active lifestyle, information on the quantity and/or type of exercises performed by the user, whether the user has any existing health issues, the quality of the user's diet, or other relevant health information.

In some embodiments, user data may include information relating to health information, or exercises prescribed by or recommended by a health professional, such as a physician, physical therapist, and so on, to address a specific injury.

In certain embodiments, App 22 is configured to use the user data 27 to generate a physical activity profile for a user. In various embodiments, the physical activity profile will include one or more physical activity programs that are selected based on the user data 27. For example, in one or more embodiments, the App 22 uses the user data 27 to determine a predicted physical activity deficiency, and select one or more physical activity programs based on the predicted deficiency. For example, the user data 27 could indicate that the user has a desk job and lives a sedentary lifestyle. From that data, the App 22 could determine that the user has a predicted physical activity deficiency of lower back weakness. As such, the App 22 could generate a physical activity profile with one or more physical activity programs which are targeted for stretching and/or strengthening the user's lower back. In an additional example, the user data 27 could indicate that the user has a job that includes lifting heavy objects and has had health issues involving their rotator cuff. As such, the App 22 could generate a physical activity profile with one or more physical activity programs which are targeted for stretching and/or strengthening the user's rotator cuff and shoulder. In various embodiments, the physical activity profile can be tailored for various different predicted physical deficiencies using the physical activity programs.

In one or more embodiments, the App 22 is configured to record the number of times a user account has completed a physical activity program. For example, the App 22 may be configured to receive user input indicating that the physical activity has been completed. For example, in some embodiments, at the completion of each physical activity, a user must make an input on the computing device 14, 16, 18, for example, a button press, to move on to the next physical activity within the program. This interaction is may act as discouragement to a user from starting a physical activity program and then walking away while the program cycles through to completion.

For example, the server, executing App 22, may check a stamp time or check off after completion. In some embodiments, the server may update user data 27 for the user account 26 based on this completion record. In some embodiments, the server, executing App 22, may then update accessible physical activity programs to the user accounts 26 based on the completion record. In some embodiments, the App 22 may generate a report summarizing the activity for the user accounts 26.

In one or more embodiments, the App 22 includes a physical activity schedule for the user accounts 26. In some embodiments, the physical activity schedule is defined by the administrative account determines how often and when physical activity programs are transmitted to the computing nodes 14, 16, 18. For example, the App 22 could include a frequency schedule that transmits a daily and/or weekly physical activity program to the computing nodes 14, 16, 18. In one or more embodiments, App 22 includes time-of-day reminders that transmitted to computing nodes 14, 16, 18, when accessing user accounts 26. In some embodiments, the administrative account defines the time of day reminders. In some embodiments, the content of the reminder may change if someone skipped doing their program for a period of time (e.g.: “it is important to complete your exercises”).

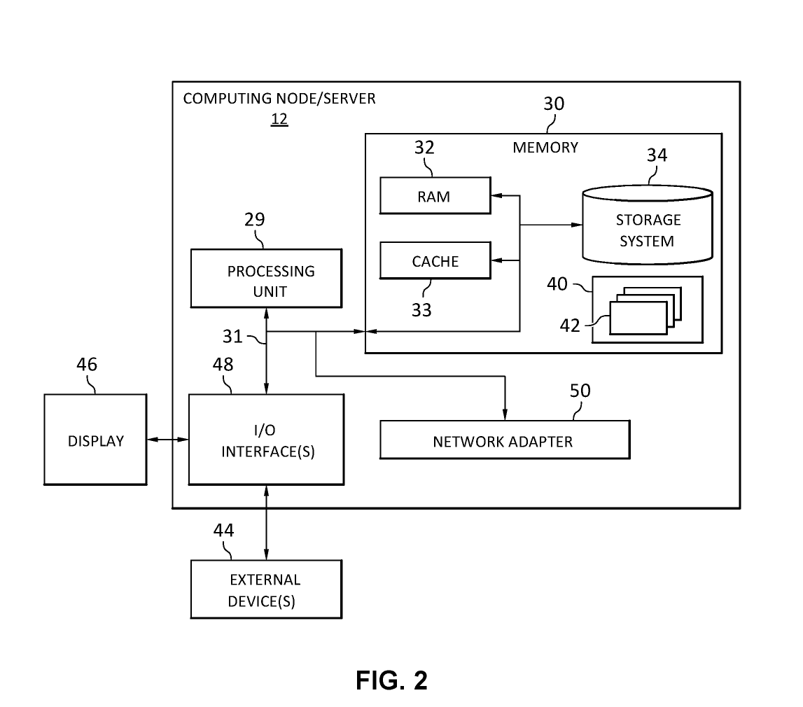

Referring now to FIG. 2, a block diagram of a computing node 12 for physical activity data management is depicted, according to one or more embodiments of the disclosure. Computing node 12 is only one example of a suitable system and is not intended to suggest any limitation as to the scope of use or functionality of the embodiments described herein. Regardless, computing node 12 is capable of being implemented and/or performing any of the functionality set forth as described herein.

Computing node/server may be is operational with numerous other general purpose or special purpose computing system environments or configurations. Examples of well-known computing systems, environments, and/or configurations that may be suitable for use with computing node/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computing node/server 12 may be described in the general context of computer system, including executable instructions, such as program modules, being executed by a computer system. Generally, program modules may include routines, programs, objects, components, logic, data structures, and so on that perform particular tasks or implement particular abstract data types. Computing node/server 12 may be practiced in distributed computing environments where tasks are performed by remote processing devices that are linked through a network. In a distributed computing environment, program modules may be located in both local and remote computer system storage media including memory storage devices.

As shown in FIG. 1, computing node/server 12 is shown in the form of a general-purpose computing device. The components of computing node/server 12 may include, but are not limited to, one or more processors or processing units 29, a system memory 30, and a bus 31 that couples various system components including system memory 30 to processor 29.

Bus 31 represents one or more of any of several types of bus structures, including a memory bus or memory controller, a peripheral bus, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing node/server 12 typically includes a variety of computer readable media. Such media may be any available media that is accessible by computing node/server 12, and it includes both volatile and non-volatile media, removable and non-removable media.

System memory 30 can include computer readable media in the form of volatile memory, such as random access memory (RAM) 32 and/or cache memory 33. Computing node/server 12 may further include other removable/non-removable, volatile/non-volatile computer storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 31 by one or more data media interfaces. As will be further depicted and described below, memory 30 may include at least one program product having a set (e.g., at least one) of program modules that are configured to carry out the functions of embodiments of the disclosure.

Program/utility 40, having a set (at least one) of program modules 42, may be stored in memory 30 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of one or more of the embodiments described herein.

Computing node/server 12 may also communicate with one or more external devices 44 such as a keyboard, a pointing device, a display 46, etc.; one or more devices that enable a user to interact with computing node/server 12; and/or any devices (e.g., network card, modem, etc.) that enable computing node/server 12 to communicate with one or more other computing devices. Such communication can occur via Input/Output (I/O) interfaces 48. Still yet, computing node/server 12 can communicate with one or more networks such as a local area network (LAN), a general wide area network (WAN), and/or a public network (e.g., the Internet) via network adapter 50. As depicted, network adapter 50 communicates with the other components of computing node/server 12 via bus 31. It should be understood that although not shown, other hardware and/or software components could be used in conjunction with computing node/server 12. Examples, include, but are not limited to: microcode, device drivers, redundant processing units, external disk drive arrays, RAID systems, tape drives, and data archival storage systems, etc.

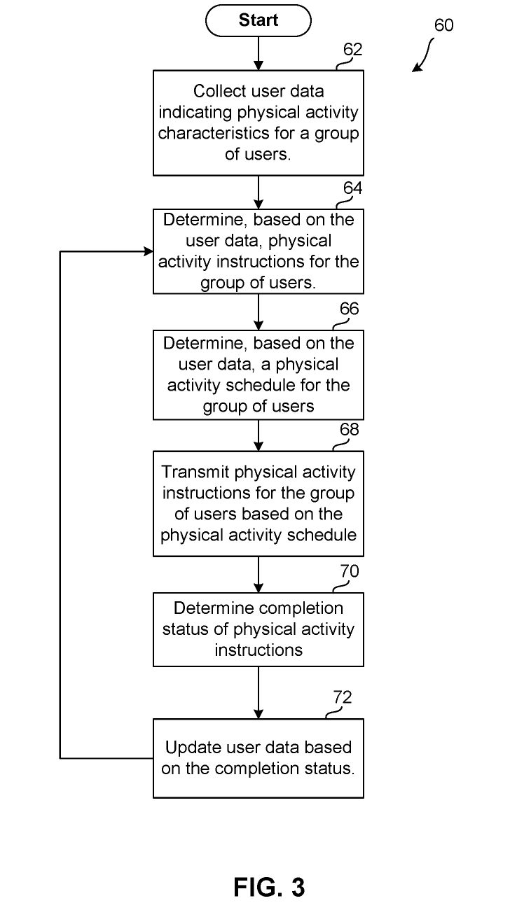

Referring to FIG. 3, a flowchart of a method 60 of managing physical activity data is depicted, according to one or more embodiments of the present disclosure.

The method 60 may include, in operation 62, collecting user data indicating physical activity characteristics for a group of users. In one or more embodiments,

The method 60 may include, in operation 64, determining based on user data, physical activity program for the group of users.

The method 60 may include, in operation 66, determining based on the user data, a physical activity schedule for the group of users.

The method 60 may include, in operation 68, transmitting physical activity instructions for the group of users based on the physical activity schedule.

The method 60 may include, in operation 70, determining a completion status of the physical activity instructions.

The method 60 may include, in operation 72, updating user data based on the completion status.

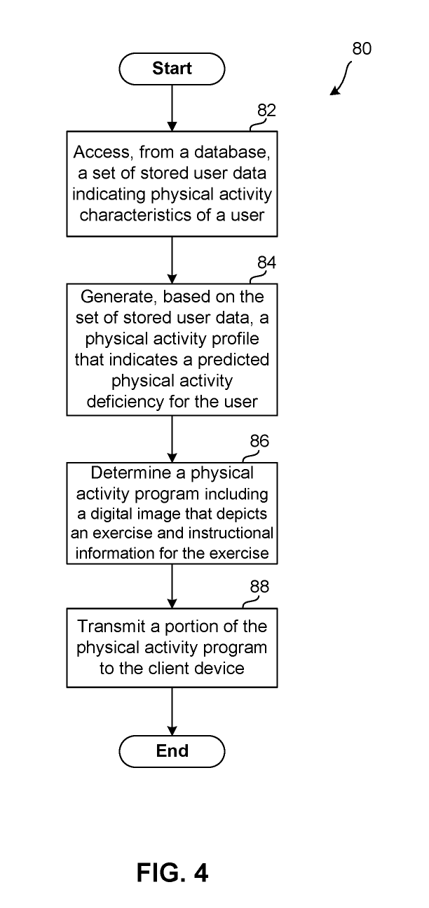

Referring to FIG. 4, a flowchart of a method 80 of managing physical activity data is depicted, according to one or more embodiments of the present disclosure.

The method 80 may include, at operation 82, accessing, from a database, a set of stored user data indicating physical activity characteristics of a user. At operation 84, the method 80 may include generating, based on the set of stored user data, a physical activity profile that indicates a predicted physical activity deficiency for the user based on the set of stored user data. At operation 86, the method 80 may include determining a physical activity program from a database of a plurality of physical activity programs, the physical activity program including a digital image that depicts an exercise and instructional information for the exercise. At operation 88, the method 80 may include transmitting, via a network, a portion of the physical activity program to the client device.

One or more embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for managing physical activity data, the system comprising
a server device and a client device, the client device associated with a user and communicatively connected with the server device via a network, the server device and the client device each including a processor and a computer readable storage medium, the computer readable storage medium of the server device including instructions executable by the processor of the server device to cause the server device to:
access, from a database communicatively connected with the server device, a set of stored user data indicating physical activity characteristics of the user;
generate, based on the set of stored user data, a physical activity profile that indicates a predicted physical activity deficiency for the user based on the set of stored user data;
determine a physical activity program from a database of a plurality of physical activity programs, the physical activity program including a digital image that depicts an exercise and instructional information for the exercise;
transmit, via a network, a portion of the physical activity program to the client device.

2. The system of claim 1, wherein the user data is determined using the client device.

3. The system of claim 1, wherein the instructions executable by the processor of the server device to cause the server device to transmit a portion of the physical activity program to the client device further cause the server device to transmit the digital image to the client device.

4. The system of 3, wherein the digital image is transmitted to the client device as a Multimedia Messaging Service (MMS) message.

5. The system of claim 1, wherein the instructions executable by the processor of the server device to cause the server device to transmit a portion of the physical activity program to the client device further cause the server device to transmit a text message to the client device, the text message including a Uniform Resource Locator linking to the digital image.

6. The system of claim 1, wherein the digital image is included among a plurality of digital images in a Graphics Interchange Format (GIF) configured to animate the depicted exercise.

7. The system of claim 1, wherein the digital image is included among a plurality of digital images in a Graphics Interchange Format (GIF) configured to animate a timer for the depicted exercise.

8. The system of claim 1, wherein the digital image is included in a video depicting the exercise and the instructional information.

9. The system of claim 1, wherein the digital image is less than 600 kilobytes (KB) large.

10. The system of claim 1, wherein the digital image is less than 300 kilobytes (KB) large.

11. The system of claim 1, wherein the physical activity program includes a timer for executing the depicted exercise and the instructional information.

12. The system of claim 1, wherein the client device is a mobile phone.

13. A method of managing physical activity data, the method comprising:
accessing, from a database communicatively connected with a server device, a set of stored user data indicating physical activity characteristics of a user;
generating, using the server device and the set of stored user data, a physical activity profile that indicates a predicted physical activity deficiency for the user based on the set of stored user data;
determining a physical activity program from a database of a plurality of physical activity programs, the physical activity program including a digital image that depicts an exercise and instructional information for the exercise;
transmitting, via a network, a multimedia message service message including a portion of the physical activity program to a client device associated with the user.

14. The system of claim 1, wherein transmitting a portion of the physical activity program to the client device includes transmitting the digital image to the client device.

15. The system of claim 1, wherein the transmitting a portion of the physical activity program to the client device includes transmitting a text message to the client device, the text message including a Uniform Resource Locator linking to the digital image.

16. The system of claim 1, wherein the digital image is included among a plurality of digital . images in a Graphics Interchange Format (GIF) configured to animate the depicted exercise.

17. The system of claim 1, wherein the digital image is included among a plurality of digital images in a Graphics Interchange Format (GIF) configured to animate a timer for the depicted exercise.

18. The system of claim 1, wherein the digital image is included in a video depicting the exercise and the instructional information.

19. The system of claim 1, wherein the digital image is less than 600 kilobytes (KB) large.

20. A computer program product for managing physical activity data, the computer program product comprising a computer readable storage medium having program instructions embodied therewith, wherein the computer readable storage medium is not a transitory signal per se, the program instructions executable by a computer to cause the computer to perform a method comprising:
accessing, from a database communicatively connected with a server device, a set of stored user data indicating physical activity characteristics of a user;
generating, using the server device and the set of stored user data, a physical activity profile that indicates a predicted physical activity deficiency for the user based on the set of stored user data;
determining a physical activity program from a database of a plurality of physical activity programs, the physical activity program including a digital image that depicts an exercise and instructional information for the exercise;
transmitting, via a network, a multimedia message service message including a portion of the physical activity program to a client device associated with the user.
